(19) United States
(12) Patent Application Publication
(10) Pub. No.: US 2025/0239706 A1
(43) Pub. Date: Jul. 24, 2025

(54) SYSTEM AND METHOD FOR MAINTENANCE OF RECHARGEABLE POWER UNITS WITH INTERCHANGEABLE COMPONENTS

(71) Applicant: Tricopian, LLC, Del Mar, CA (US)

(72) Inventor: Chi W. Yau, Escondido, CA (US)

(21) Appl. No.: 19/030,912

(22) Filed: Jan. 17, 2025

Related U.S. Application Data
(60) Provisional application No. 63/622,466, filed on Jan. 18, 2024.

(51) Int. Cl. H01M 50/233; H01M 10/42; H01M 10/46; H01M 10/48; H01M 50/284

(52) U.S. Cl. CPC H01M 50/233; H01M 10/425; H01M 10/46; H01M 10/48; H01M 50/284; H01M 2010/4278

(57) ABSTRACT

A rechargeable power unit with interchangeable components that are able to be removably housed within the housing. The modular components are separately replaceable and are designed as interchangeable so they are able to be separately replaced if only one components fails within the rechargeable power unit. Instead of having to discard the whole rechargeable power unit, only the failed component will need to be replaced. Once the failed component is replaced, the circuitry portion can be updated and stored with software or firmware given a new unit identifier.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 63/622,466, filed Jan. 18, 2024, the entire contents of which are hereby incorporated by reference.

### BACKGROUND

This disclosure relates to the field of portable, rechargeable, electric power supplies.

### SUMMARY

In some aspects described herein, a rechargeable power unit comprises a body; a battery cell removably positioned within the body; a board comprising a processor, a memory, an input/output port, and a battery connection removably connected to the battery cell; a casing removably connected to the board via a mechanical connection; and a connection portion removably connected to the body, the connection portion housing at least a portion of the casing and the board and including an opening configured to provide access to the input/output port.

In some embodiments, the rechargeable power unit further comprises a wireless charging coil, the wireless charging coil removably connected to the board.

In some embodiments, the body has a computer readable code located thereon.

In some embodiments, the memory is configured to store a battery identifier, processor identifier, and the computer readable code located on the body.

In some embodiments, the processor is further configured to determine one or more attributes of the battery cell, the board, and the body, and store the one or more attributes in the memory.

In some embodiments, the one or more attributes comprise battery service date, number of charge-discharge cycles, average of battery percentage increased per charge of rechargeable power unit, number of times interchangeable component has been replaced, and number of days since interchangeable component has been replaced.

In some embodiments, the casing comprises one or more prongs extending from a surface thereof and wherein the board comprises one or more slots configured to receive the one or more prongs of the casing such that a secure friction fit is formed between the casing and the board.

In some embodiments, the casing fits within the connection portion such that the casing is removably secured within the connection portion and the input/output port of the board is aligned with the opening in the connection portion.

In some embodiments, the rechargeable power unit further comprises a sealing strip covering at least a portion of a joint between the connection portion and the body.

In some embodiments, the sealing strip further comprises one or more electrical contacts in communication with processor, and wherein removing the sealing strip breaks the one or more electrical contacts, and wherein the processor is configured to prevent operation of the rechargeable power unit where the one or more electrical contacts are broken.

In another aspect described herein, a method of maintaining a rechargeable power unit comprises scanning, by a scanner, a rechargeable power unit to read an identifier associated with the rechargeable power unit, the rechargeable power unit comprising a body, a casing, a board, and a battery cell, the board removably connected to the battery cell and the board removably connected to the casing and the body housing the battery cell; storing in a processor on the board, item information, the item information including a unique battery identifier, a unique processor identifier, and the identifier associated with the rechargeable power unit; receiving item information for components of the rechargeable power unit; identifying, based on the item information, that one or more components of the rechargeable power unit need to be replaced; determining, based on the identifying that one or more components need to be replaced, which of the board, battery cell, and body needs to be replaced; and storing, in the memory of the board, an updated identifier corresponding to a replacement component.

In some embodiments, the method further comprises running a diagnostic test of the rechargeable power unit; determining, based on the diagnostic test, that the battery cell needs to be replaced; and wherein storing the updated identifier comprises storing, in the memory, a new unique identifier corresponding to a replacement battery cell.

In some embodiments, scanning the rechargeable power unit comprises making an electrical connection with the scanner and the rechargeable power unit in a receptacle.

In some embodiments, scanning the rechargeable power unit comprises making a wireless connection between the receptacle and the rechargeable power unit; and receiving the item information from the rechargeable power unit via the wireless connection.

In some embodiments, the method further comprises receiving, from a user via a user interface, trouble information for the rechargeable power unit; and wherein identifying, based on the item information, that one or more components of the rechargeable power unit need to be replaced further comprises identifying, based on the item information and the trouble information, that one or more components of the rechargeable power unit need to be replaced.

In some embodiments, the user interface is connected to a receptacle configured to receive the rechargeable power unit.

In some embodiments, the user interface is embodied as an application running on a user device.

In some embodiments, receiving the item information for the components of the rechargeable power unit comprises receiving the item information from the processor on the board via the scanner.

In some embodiments, the method further comprises updating, by a server in a memory remote from the rechargeable power unit, the updated identifier corresponding to the replacement component.

In some embodiments, receiving the item information for the components of the rechargeable power unit comprises: querying, by a server, a memory remote from the rechargeable power unit, using the scanned identifier; and receiving, from the memory, the item information for the components of the rechargeable power unit.

### BRIEF DESCRIPTION OF THE DRAWINGS

FIG. 1 is a system diagram for the system for the maintenance of rechargeable power units with interchangeable components.

FIG. 2A is a perspective view of an embodiment of a rechargeable power unit.

FIG. 2B is a top view of an embodiment of a rechargeable power unit.

FIG. 2C is a cutaway view of an embodiment of a rechargeable power unit with interchangeable attachments from a right-side view.

FIG. 2D is an exploded perspective view of the internals of an embodiment of a rechargeable power unit with interchangeable attachments.

FIG. 2E is an exploded view of a portion of the internals of a rechargeable power unit.

FIG. 2F is an exploded perspective view of an embodiment of a rechargeable power unit.

FIG. 3A is a perspective view of an embodiment of a rechargeable power unit.

FIG. 3B is a view of the internals of a rechargeable power unit when the sealing strip is broken.

FIG. 4A is an exploded perspective view of an embodiment of a rechargeable power unit.

FIG. 4B is a perspective view of an embodiment of a rechargeable power unit.

FIG. 4C is a perspective view of an embodiment of a rechargeable power unit with a transparent outer portion of the rechargeable power unit.

FIG. 4D is a perspective view of an embodiment of a rechargeable power unit depicting an outer surface as transparent or ease of viewing the internals of the rechargeable power unit.

FIG. 4E is a cross-section view of an embodiment of a rechargeable power unit.

FIG. 5 includes a series of views of an embodiment of a rechargeable power unit with an identifier on top of one of the sides of the rechargeable power unit.

FIG. 6 includes a series of views of an embodiment of a rechargeable power unit.

FIG. 7 is an exemplary flow chart illustrating an exemplary process for maintenance of a rechargeable power unit received.

FIG. 8 is an exemplary flow chart illustrating an exemplary process for maintenance of a rechargeable power unit received having been previously assigned a trouble ticket.

FIG. 9 is an exemplary flow chart illustrating an exemplary process for maintenance of a rechargeable power unit received and configured with a component replaced.

### DETAILED DESCRIPTION

In the following detailed description, reference is made to the accompanying drawings, which form a part hereof. In the drawings, similar symbols identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Embodiments of a rechargeable power unit with interchangeable parts is disclosed. Also disclosed are multiple embodiments of the method of changing those interchangeable and configuring them to the rechargeable power unit they were placed in. Although certain embodiments of the present invention are shown and described in detail, it should be understood that various changes and modifications may be made without departing from the scope of the appended claims. The scope of the present application is in no way limited to the number of constituting components, the materials thereof, the quantities thereof, the relative arrangement thereof, etc.

For ease of description and illustration, the term “standard form factor” or its variants may be used. Typical cylindrical batteries such as AAA, AA, C and D may be described as having “standard form factors.” However, one of skill in the art will recognize that batteries of many shapes and sizes having less common form factors including 9V, prismatic batteries, or coin-shaped batteries may be comprising the features described herein without departing from the scope of the present disclosure. Also, it is contemplated that some embodiments may not include all of the recited materials, thus sub-combinations of the listed materials are contemplated.

Batteries power a variety of devices. As more devices become battery powered, consumer demand for batteries increases. Common consumer electronics and appliances require a battery or power source. Having a portable battery or power source which can easily be carried is advantageous for allowing extended operation of a electronic device, such as a smartphone or tablet computer. A rechargeable power unit can be advantageously carried by a consumer to recharge an electronic device when the device runs out of power. Rechargeable power units, however, can lose effectiveness or have shortened battery life, or can have reduced recharging ability as the devices age, as they experience charge-discharge cycles, etc. The rechargeable power units can be self-contained or sealed, and when one component of a rechargeable power unit fails, becomes defective, or loses efficiency, the rest of the power unit also becomes less effective or unusable. Typically such a device is then disposed of, resulting in electronic waste and the need to manufacture more entire rechargeable power units.

However, when one component of a rechargeable power unit fails, other components of the rechargeable power unit may still be functional. For example, if a charging connection, or a controller fails, the power cell may still have useable life. If the power cell loses efficiency due to a high number of charge-discharge cycles, the other components, controllers, and connectors are not defective and do not need to be disposed of. Therefore, a rechargeable power unit having easily replaceable or configurable components is needed and is desirable.

A rechargeable power unit, such as those described herein, may wear out, malfunction, fail, or stop working due to failure of one or more components. To minimize waste and promote green power, systems and methods described herein provide for easy or improved replacement of only the failed component or components. By having modular components that are separately replaceable, interchangeable components can be used to repair malfunctioning or failed components in a rechargeable power unit. For example, a rechargeable power unit has a power unit, such as a battery, a circuitry portion having a processor and one or more ports, and an enclosure or housing. The battery can be removably connected to the circuitry portion, and the battery and circuitry portion can be removably housed within the housing. If only the battery has failed, the battery can be disconnected from the circuitry portion via a removable connector, the battery replaced with another battery and the assembly can be returned to the housing. The circuitry portion can be updated with software or firmware to with a new battery identifier, previously stored battery information can be removed, updated, or overwritten in the circuitry portion, etc. These concepts and others will be described in greater detail in the following paragraphs.

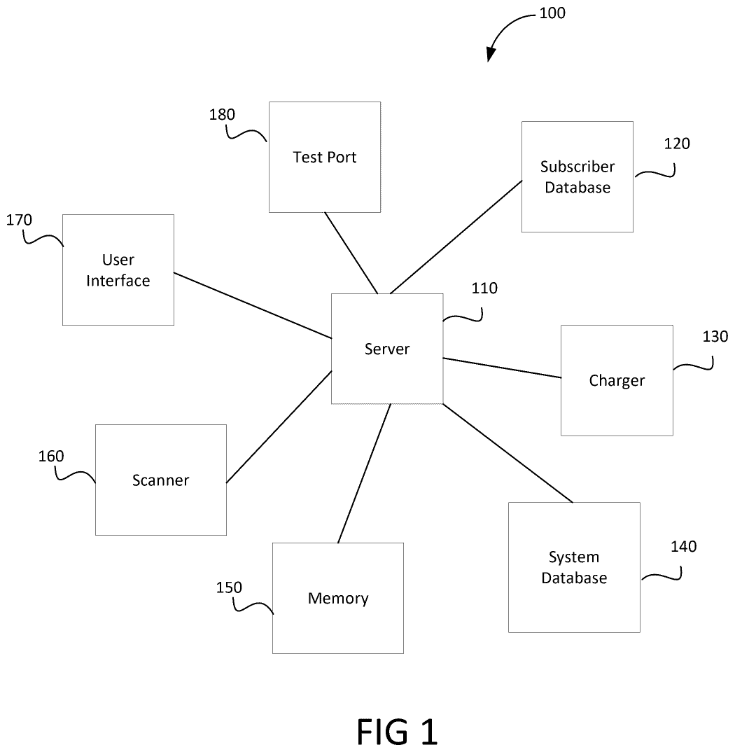

FIG. 1 is an exemplary system diagram for the maintenance of rechargeable power unit with interchangeable components. The maintenance system 100 includes a server 110, a subscriber database 120, a charger 130, a system database 140, a memory 150, a scanner 160, a user interface 170, and a test port 180.

The server 110 comprises one or more processors or similar data processing components or circuits that are able to receive information from the other parts of the maintenance system 100 and process them in a fashion that allows the maintenance of rechargeable power units 200. The server 110 is in communication with the other components of the maintenance system 100.

The subscriber database 120 stores information of all the subscriptions that the maintenance system 100 holds. In some embodiments, the subscriber database includes, but is not limited to, names, phone numbers, email addresses, physical address, payment information, serial numbers or identifiers of rechargeable power units held or associated with a subscriber, etc.

The charger 130 comprises a physical port for the rechargeable power unit 200 to be charged. In some embodiments the physical port may include a Micro-USB, Type-A charger, Type-B charger, USB Type-C Cable, or the like. In some embodiments, the port can be a wireless communication interface, such as Bluetooth®, NFC, or the like. The charger 130 connects a rechargeable power unit to the server 110 via a wired or wireless connection. When a connection is made with a rechargeable power unit and the server 110, the server 110 can run diagnostic programs on the rechargeable power unit to determine the health of a rechargeable power unit, and whether maintenance, charging, replacement, refurbishment, and the like is required.

The system database 140 comprises a list of rechargeable power units and associated identifiers that have been bought, borrowed, vended, tec. a list of the amount of charges and/or discharges each rechargeable power unit has undergone, unique identifiers of rechargeable power units, the quantity of rechargeable power units that the current maintenance system has in stock, the number of times a rechargeable power unit has been vended and/or returned, the number of times a rechargeable power unit has been returned for broken parts, the number of times a rechargeable power unit has been replaced for broken parts and was able to be fixed, the number of times a rechargeable power unit was returned to the user with an interchangeable part, the amount of times an interchangeable part failed, and the amount of which each rechargeable power unit has been fixed, the length of service of each interchangeable part, serial numbers, manufacturer codes, the identities of the or any other desirable or helpful information in assessing the status of a rechargeable power unit and its parts.

The memory 150 stores information received from the other components. The memory 150 can store program information, algorithms, diagnostic programs, instructions for execution by the server 110, and the like.

The scanner 160 scans information provided by the user. In some embodiments, the scanner 160 may scan a barcode and populate information for the specific rechargeable power unit available. The scanner 160 may also be provided with other information such as a unit number, part number, or troubleshoot ticket that it can scan and populate information regarding the rechargeable power unit.

The user interface 170 allows a user to interface with the maintenance system 100. The user interface 170 may be embodied in a kiosk with a graphical interface, a touch screen, soft keys or buttons, and the like. In some embodiments, the maintenance system 100 can be within a kiosk used for vending and receiving rechargeable power units. The kiosk can have one or more receptacles to receive rechargeable power units, and the receptacles can have the functionality described herein. In some embodiments, the user interface 170 is the point of contact with the maintenance system of rechargeable power units. The user interface 170 may include varying options for the user to input information about the rechargeable power unit. In some embodiments, the user interface 170 may ask for a barcode associated with the rechargeable power unit, or may automatically scan a computer readable code on the rechargeable power unit, such as a barcode or RFID tag, or communicate via a Bluetooth® connection with the kiosk as the rechargeable power unit approaches or is inserted into the kiosk.

In some embodiments, the user interface 170 and the maintenance system can be used or operated by a technician or a customer. In some embodiments, the user interface 170 may ask for a trouble ticket or may generate a trouble ticket. For example, if a user has a problem with a rechargeable power unit, the user may, via the user interface 170 on a kiosk, or via a user interface on a user computing device, report an issue with a rechargeable power unit. The user may receive a trouble ticket identifier, such as a barcode or other electronic or physical identifier that can be input at the user interface 170. A user may have a trouble ticket that corresponds to a rechargeable power unit that the user has. In some embodiments, the trouble ticket may include information such as the unit number of the rechargeable power unit, the date the user purchased or received the unit, the number of charges the unit has had, the interchangeable component that seems to be broken, and the process for which the unit may be fixed. In some embodiments, the user will put the trouble ticket information in the user interface 170. In some embodiments, the user interface 170 will already have the information from the trouble ticket already uploaded and the user will only need to scan a barcode or enter a unit number for the rechargeable power unit 200.

In some embodiments, the user interface 170 may be an application or computer interface. The user interface 170 may be a website that users are able to log on and report problems that they are having with the rechargeable power unit 200. From the input received on the user interface 170, a trouble ticket may then be created for the associated rechargeable power unit 200 that the user has. As a user approaches a kiosk or similar device, the application or computer interface, such as a mobile application on a user's smartphone can communicate with the kiosk and report the rechargeable power unit identifier, rechargeable power unit information, and any user identified issues. In some embodiments, the user interface 170 can be both at the kiosk and on an application, website, or mobile computing device, where the same, different, or complementary functions are available on the application and the kiosk.

The test port 180 contains a physical connection or wireless charging component which for charging the rechargeable power unit. In some embodiments, the test port 180 runs diagnostics tests on the rechargeable power unit to figure out what components are malfunctioning, component status, charge-discharge cycle quantity, battery health, or any other characteristics or attributes of the components of the rechargeable power unit. In some embodiments, the test port 180 also runs diagnostics on a rechargeable power unit that has already had its interchangeable components replaced to make sure that rechargeable power unit is working properly.

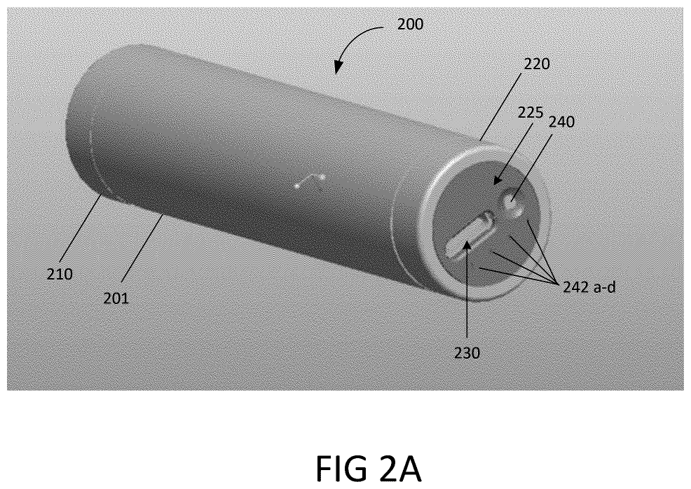

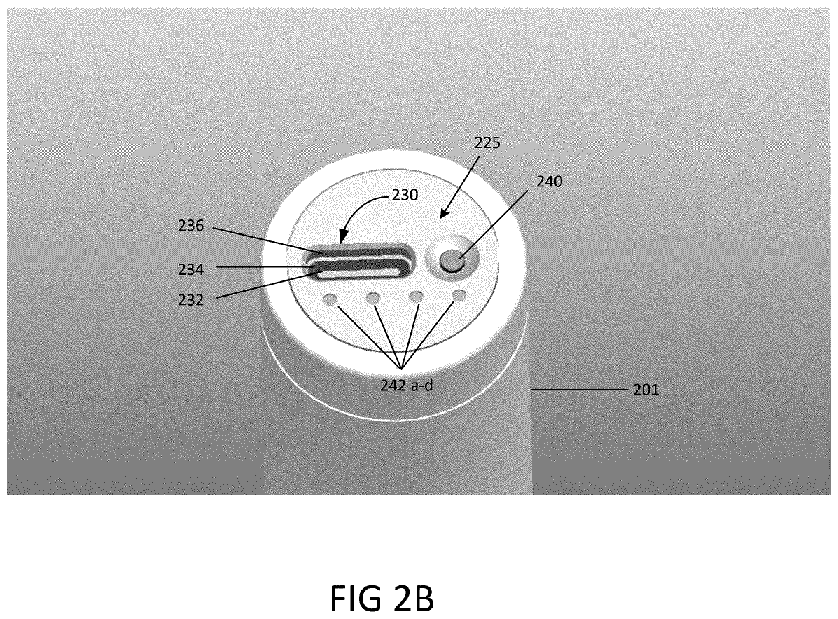

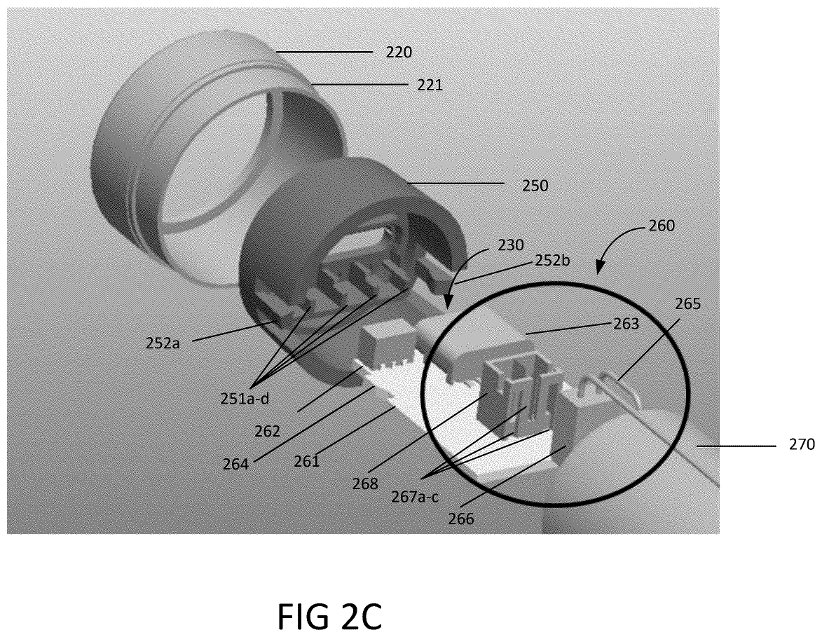

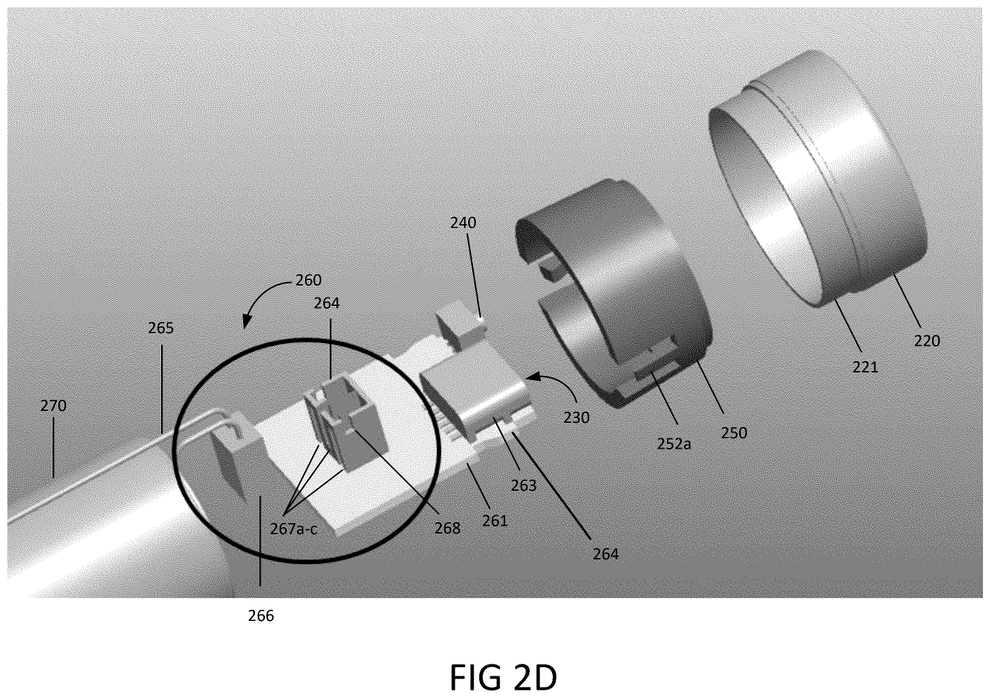

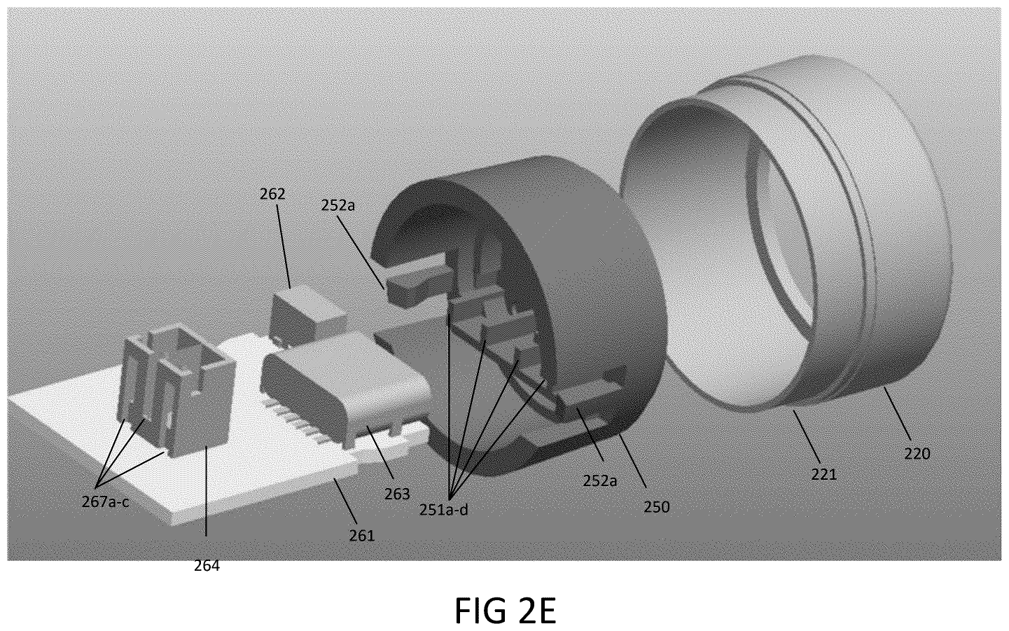

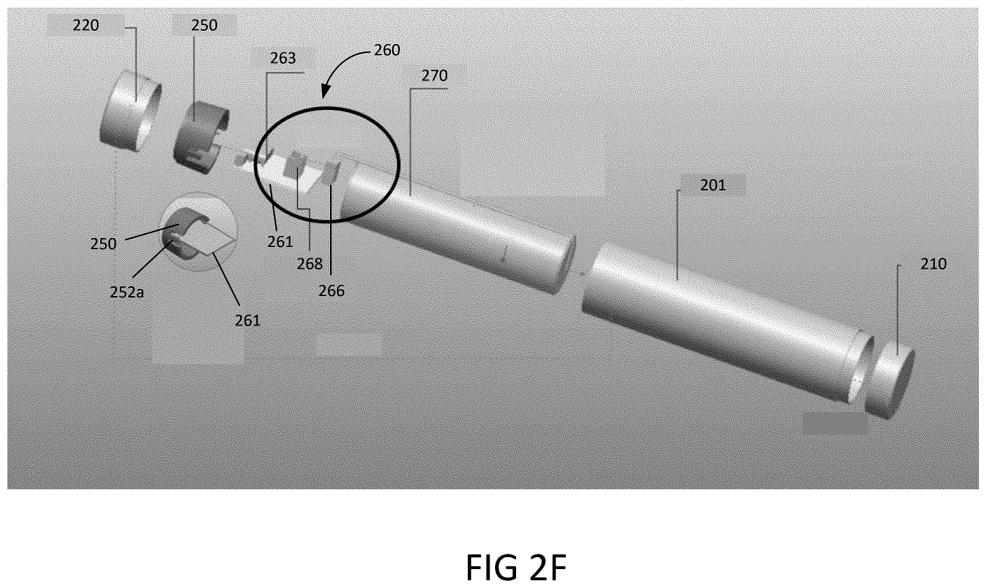

FIG. 2A is a perspective view of an embodiment of a rechargeable power unit 200. A rechargeable power unit 200 is comprised of a housing or body 201, a cap 210, a connection portion 220, a port 230, a button 240, one or more indicators, such as lights 242a-d.

The body 201 is a housing cell for all the components of the rechargeable power unit 200. The cap 210 is removably connected to the body 201. The cap 210 may have a security feature which prevents the user from easily removing it such as requiring a specific tool or a security covering or wrapper or tamper evident material. The cap 210 has the security feature so a user is not able to get to the inner components within the body 201. The cap 210 can be removed to allow access to the internal components of the rechargeable power unit.

The connection portion 220 connects to the body 201 and includes surface 225 which has electrical features formed therein or thereon. The surface 225 includes the port 230, the button 240, and the one or more lights 242a-d. The connection portion 220 is connected to the body 201 via a locking mechanism configured to be operated by a custom or unique tool having complementary features to the locking mechanism.

In some embodiments, the port 230 may be a Micro-USB, Type A charger, Type B charger, or USB Type C Cable, or any other connector configuration. In some embodiments, the port 230 may function as an input/output port or a charge/discharge port.

The button 240 can serve as a power on/off function. In some embodiments, the button 240 serves as a check on the charge level of the rechargeable power unit 200. In some embodiments, the lights 242a-d also serve to show the charge level of the rechargeable power unit 200. In some embodiments, the user can push the button 240 and depending on the charge level of the rechargeable power unit 200 any number of lights 242a-d or none at all will blink. In some embodiments, pressing the button 240 communicates or broadcasts relevant information about the rechargeable power unit and its components to a kiosk or other processor, and in some embodiments the button 240 facilitates establishing a Bluetooth® connection.

FIG. 2B is a top view of an embodiment of a rechargeable power unit. The port 230 includes a center 232 of the port, a magnetic surface 234 and a tapered surface 236. The tapered surface 236 helps guide the cable or connector inwards toward the center 232 make positive connection with the port 230. The tapered surface 236 removes the need to perfectly or precisely position a connector to mate with the port 230, and instead, if the connector is close enough, the tapered surface 236 will guide the connector to the center 232 of the port 230 where a positive electrical connection can be made. The tapered surface 236 has a decreasing diameter moving toward the center 232 of the port 230. This can be advantageous when an automated system or component is connecting a connector to the rechargeable power unit, such as, for example, in the maintenance system 100 in a kiosk. The magnetic surface 234 creates a magnetic force for the cable to stay within the port and be easily guided or urged toward the center 232 of the port 230. The different components of the port 230 make it easier for a user to guide the cable to the port 230. FIG. 2B as previously described also includes the surface with electrical contacts 225 that includes the button 240, and the lights 242a-d.

FIG. 2C is an exploded perspective view of an embodiment of the rechargeable power unit 200 with interchangeable attachments. The connection portion 220 and body 201 house most of the interchangeable components. The interchangeable components include a casing 250, a circuitry unit 260, and a battery cell 270. In some embodiments, the casing 250 and the circuitry unit 260 are housed mostly within the connection portion 220.

The casing 250 is cylindrical with one or more threads or prongs 251a-d. The one or more threads or prongs 251a-d can act as guides for connecting the circuitry unit 260 to the connection portion 220. In some embodiments, the one or more threads or prongs 251a-d promote a friction fit of the circuitry unit 260 to the casing 250. The one or more threads or tons 251a-d are formed with a notch or tab formed thereon configured to removably friction fit within a complementary portion of the circuitry unit 260. The circuitry portion 260 can comprise complementary guides or friction fit components (not shown) to receive the threads or prongs 251a-d. On the outside of the casing 250 there are outside locking tabs 252a-b. The locking tabs 252a-b connect to complementary locking features 264 formed on either side of the circuitry portion 260 which receive the locking tabs 252a-b, thereby removably securing the circuitry portion 260 to the casing 250.

In some embodiments, the casing 250 does not include the locking tabs 252a-b. In some embodiments, the casing 250 may include more than two locking mechanisms 252a-b.

The circuitry unit 260 includes a board 261, a processor 262, a port housing 263, and a battery connector 268. The processor 262 can control the operations of the rechargeable processing unit 200. The port housing 263 comprises a housing for the connection port which is accessible through the connection portion 220.

The board 261 supports the processor 262, the port housing 263, and the battery connector 268, and wiring or circuits between the components. The processor 262 can include or be in communication with a memory or storage device. The battery connector 268 has grooves 267a-c on the outside perimeter that correspond to grooves on the battery leads 265. In some embodiments, the grooves 267a-c could be placed in varying waying across the battery connection box 268 and provide a guide for connecting the battery leads 265 and a battery plug 266 to the battery connector in a certain direction.

The battery cell 270 is connected to battery leads 265 that connect the battery cell 270 to a battery plug 266. The battery plug 266 fits within the battery connector 268. In some embodiments, the battery plug 266 may have edges on its side so as to fit through or align with the grooves 267a-c of the battery protection box 268 to securely and removably maintain the battery plug 266 in electrical connection with the components of the circuitry portion 260.

The connection portion 220 includes an inside surface 221 that is adapted to fit within and secure to the casing 250. The inside surface 221 is an extension of the connection portion 220 with a smaller diameter so it is able to be interchangeable within the rechargeable power unit 200.

Because each component, the body 201, the circuitry portion 260, and the battery cell 270 are removably connected to each other, each of these three components can be interchangeable and independently replaced. If the battery cell 270 nears the end of its life cycle, a new battery cell 270 can be connected to the existing circuitry portion 260 and only the battery cell 270 needs to be disposed of. Similarly, if something in the circuitry portion 260 has failed, such as a bad electrical connection in the port 230, or the processor 262 has a defect or failure, a new circuitry portion can be connected to the healthy battery cell 270 and to the existing casing 250, and reinstalled in the body 201.

FIG. 2D is a left perspective view of an embodiment of the rechargeable power unit 200 as described herein.

FIG. 2E is an exploded view of an embodiment of a rechargeable power unit 200 as described herein.

FIG. 2F is an exploded perspective view of an embodiment of the rechargeable power unit 200. The battery cell 270 and other components are shown removed from the body 201

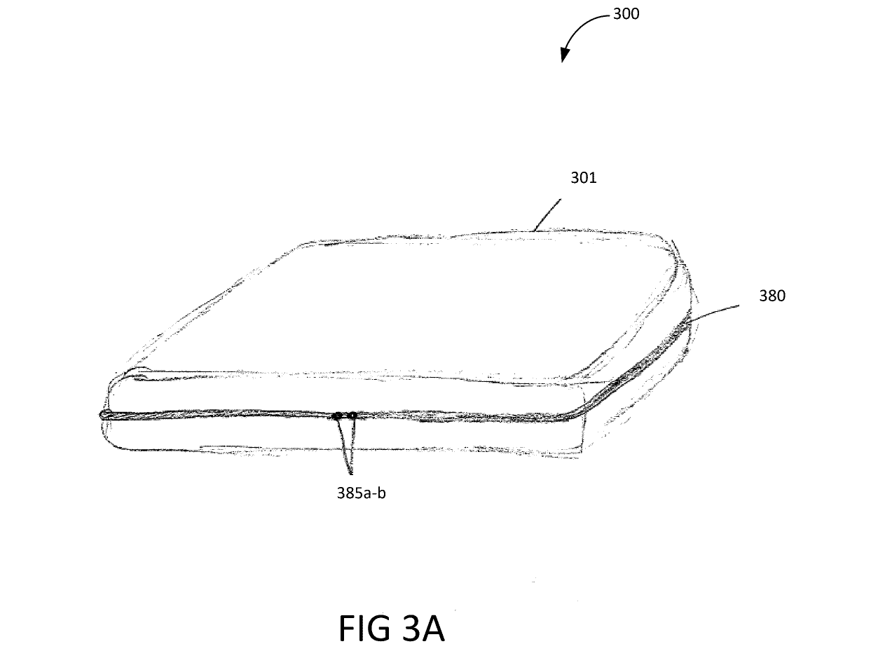

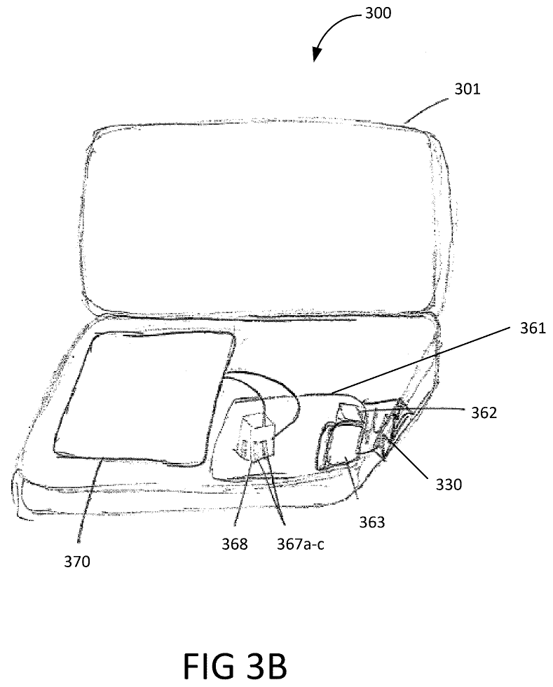

FIG. 3A is a perspective view of an embodiment of a rechargeable power unit 300. The rechargeable power unit 300 may be similar to those described elsewhere herein. The battery cell 370 includes a sealable strip 380 on the circumference of the battery cell 370. The sealable strip 380 seals all of the different components within the battery unit 370 and prevents access to the internals of the rechargeable power unit, or identifies when the rechargeable power unit has been opened or tampered with. The sealable strip 380 could be made of a variety of plastic materials including both synthetic and semi-synthetic materials such as polyethylene. The sealable strip 380 is manufactured and positioned surrounding the battery cell 370 so that it can be easily removed to expose the interchangeable components within the battery cell 300. In the rechargeable power unit 300, the body 301 can be opened by removing the sealable strip 380. Removing the sealable strip 380 can inactivate the rechargeable power unit by disconnecting or interrupting a wired connection between the battery 370 and the circuitry portion 360. In some embodiments, the processor 362 can have a sensor or can detect when the sealable strip is removed and/or when the body 301 is opened via hinge sensor or destruction of an electrical link between components when the case is opened. The sealable strip 380 may need to be replaced following maintenance or replacement of components of the rechargeable power unit 300 in order for the rechargeable power unit 300 to be usable again.

The sealable strip 380 may include tab 385a-b to make it easily to break apart the sealable strip 380 and expose the interchangeable components within the battery cell 300. The tabs 385a-b cannot be repaired but must be replaced in order to reseal the body 301.

FIG. 3B is a cutaway view of an embodiment of a rechargeable power unit when the sealing strip is broken and the rechargeable power unit is opened up displaying the different components. The rechargeable power unit 300 includes a battery cell 370, a battery connector 368, a port 330, a processor 362, and a board 361. The battery cell 370 is connected to the battery connector 368.

The battery connector 368 has grooves 367a-c that allow the battery connector 368 to be secured on the board 361. The port is also on the board 361 that allows a power cord to be inserted. The port 230 is housed in the port housing 363. The port housing 363 is connected to the processor 362 and the battery connector 368.

The board 361 supports the processor 362, the port housing 363, and the battery connector 368, and wiring or circuits between the components. The processor 362 can include a memory or storage device on the board 361. The processor 362 can control the operations of the rechargeable processing unit 300. The battery connector 368 has grooves 367a-c on the outside perimeter that correspond to grooves on the battery leads 365. In some embodiments, the grooves 367a-could be placed in varying waying across the battery connection box 368 and provide a guide for connecting the battery leads 365 and a battery plug 366 to the battery connector in a certain direction. Similar to other embodiments, the battery can be easily disconnected from the board 361 and removed from the body 301. Similarly, the port housing 363 can be removably secured within the body 301 such that it can be disconnected from the battery cell 370 and removed from the body 301 for easy replacement of the board. Any of the components described herein can be interchangeable and replaceable.

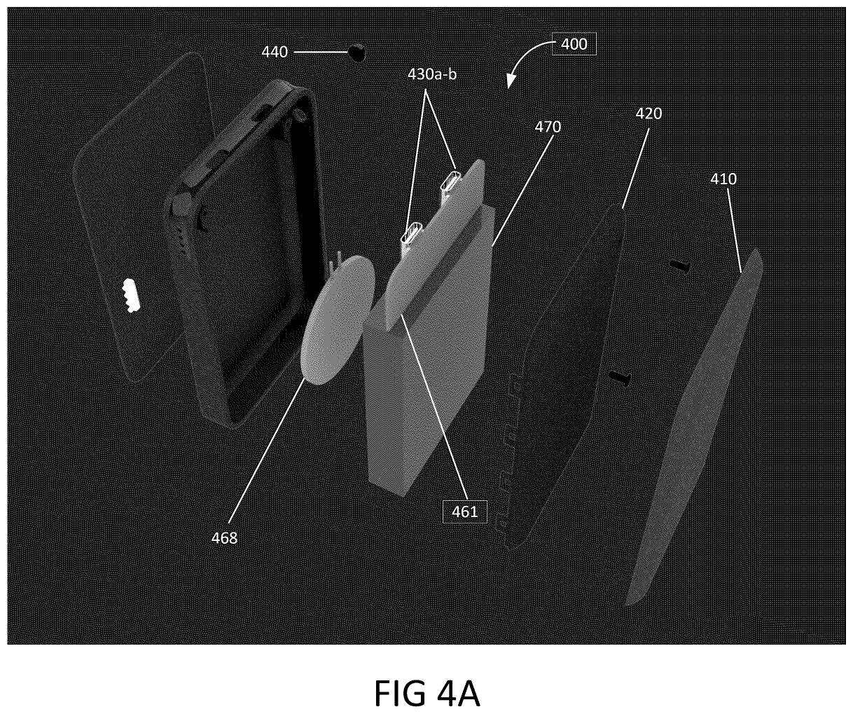

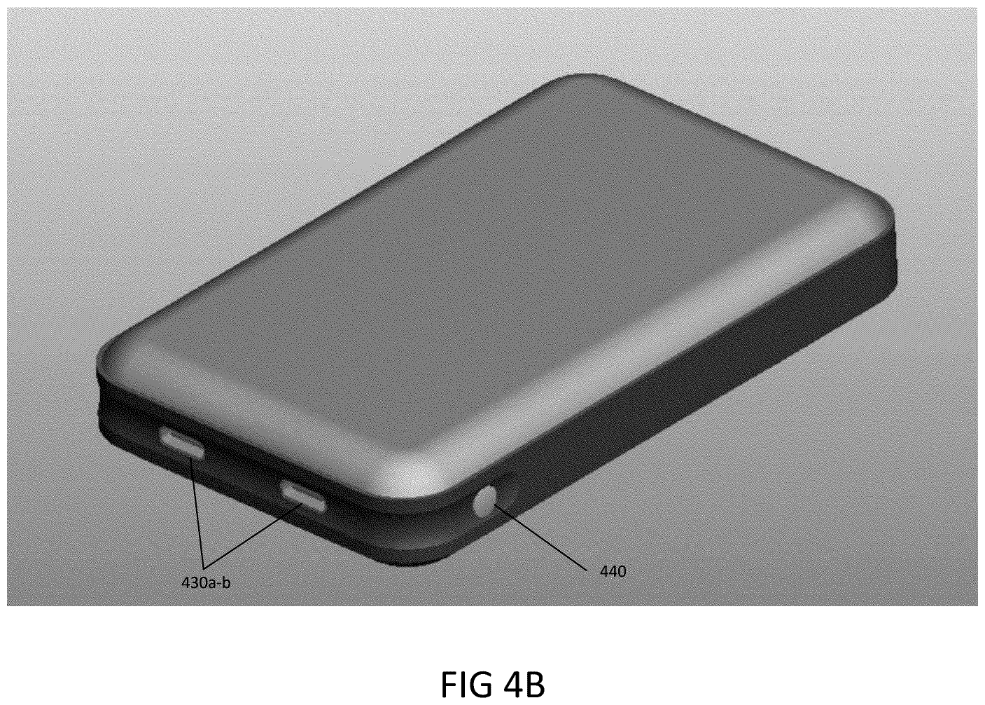

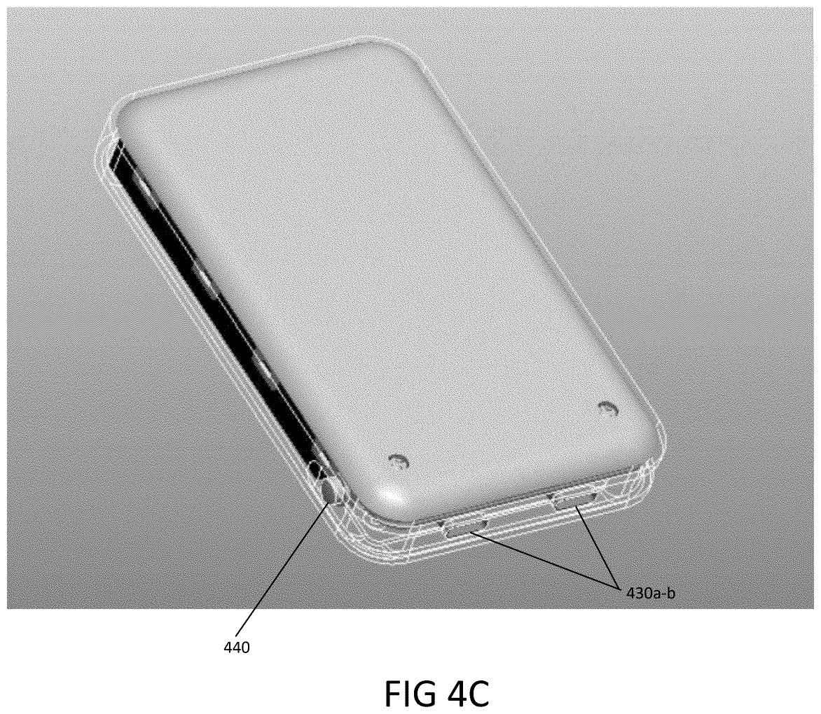

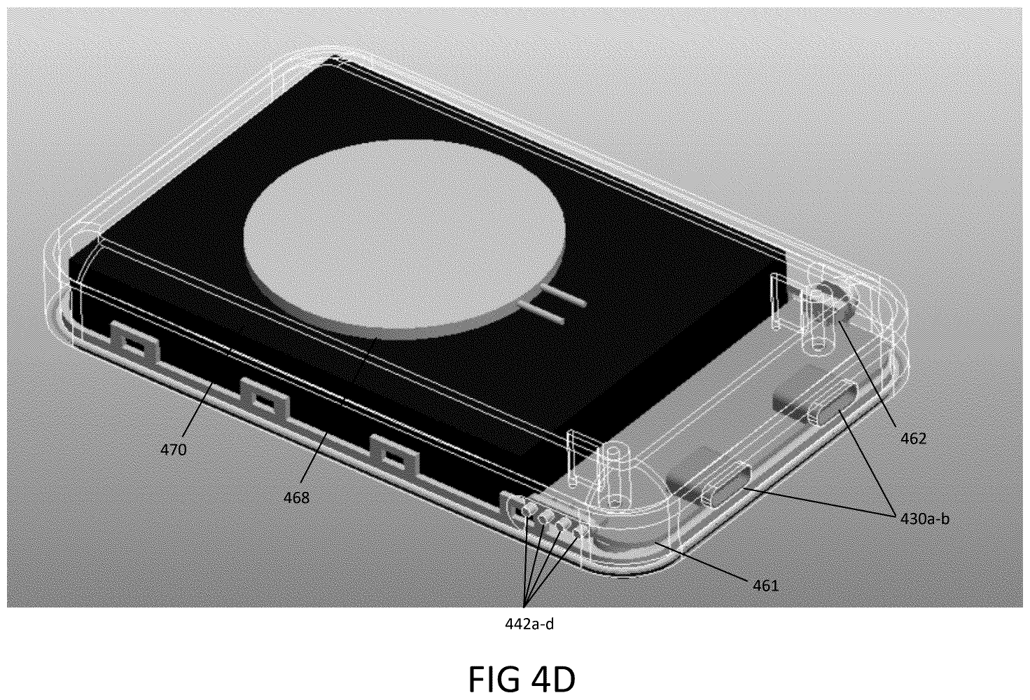

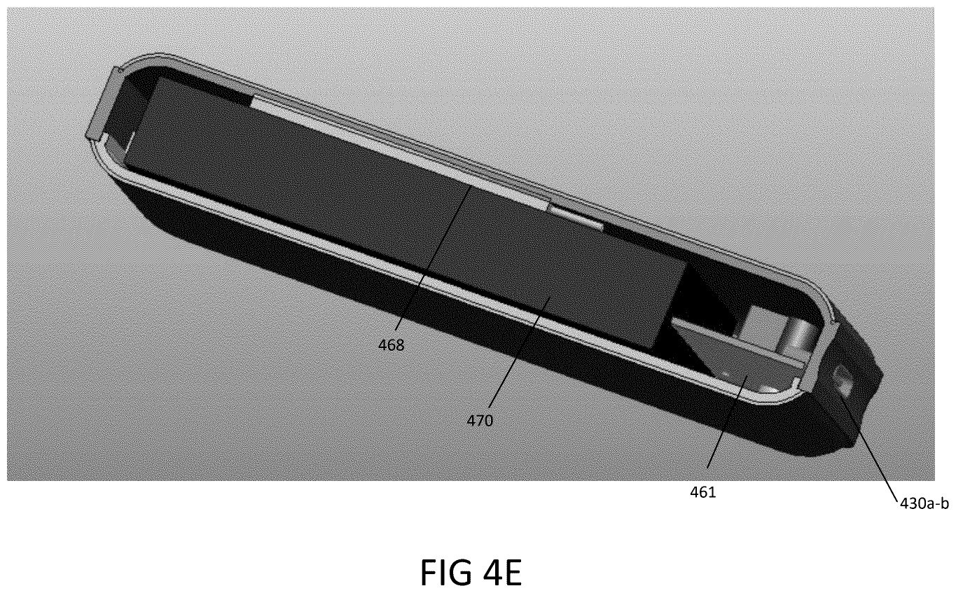

FIG. 4A is an exploded perspective view of an embodiment of the rechargeable power unit 400 with interchangeable components. The rechargeable power unit 400 may be similar to those described elsewhere herein and may include a sealing strip as described elsewhere herein. The rechargeable power unit 400 includes a cover 410, a casing 420, ports 430a-b, a button 440, lights 442a-d, a battery cell 470, a transmitter coil 468, a processor 462, and a board 461. The battery cell 470 is connected to the transmitter coil 468.

The transmitter coil 468 allows for wireless charging of a device. A device can be placed on top of the rechargeable power unit 400. The transmitter coil will send out a signal and if the device has wireless capabilities, then the device will be able to be charged through the contact with the rechargeable power unit 400 instead of being plugged into the rechargeable power unit 400 via a wireless power transfer using any existing wireless charging protocol.

The ports 430a-b of the rechargeable power unit are able to charge multiple electronic devices at the same time. Two different devices can be plugged into one port 430a of the rechargeable power unit 400 while the other device can be plugged into the second port 430b, giving the two devices the capability to be charged at the same time.

The button 440 may power the rechargeable power unit 400 on and off. The button 440 can be used to turn the wireless charging capabilities of the rechargeable power unit 400 on. Further, the button 440 may also be used to show how much the battery cell 470 is charging via the lights 442a-d. The button 440 may illuminate the number of lights 442a-d that would correspond to the charge level of the battery cell 470. For example, if the rechargeable power unit 400 has four lights and when the button 440 is pressed all four light up, then the battery cell 470 is fully charged. If only two of the lights out of the four light up then the battery cell 470 is 50% charged, and other functionality described elsewhere herein.

FIG. 4B is a perspective view of an embodiment of the rechargeable power unit 400 as described herein.

FIG. 4C is a perspective view of an embodiment of a rechargeable power unit 400 with a cutaway bottom portion of the rechargeable power unit as described herein.

FIG. 4D is a perspective cutaway view of an embodiment of a rechargeable power unit 400 as described herein. The transmitter coil 468 has a removeable connection (not shown) to the board 461 to allow for replacement of a faulty transmitter coil 468. The battery cell 470 has a removable connection to the board 461 similar to those described elsewhere herein.

FIG. 4E is a cutaway view of an embodiment of a rechargeable power unit 400 where the cutaway is in the middle of the rechargeable power unit 400.

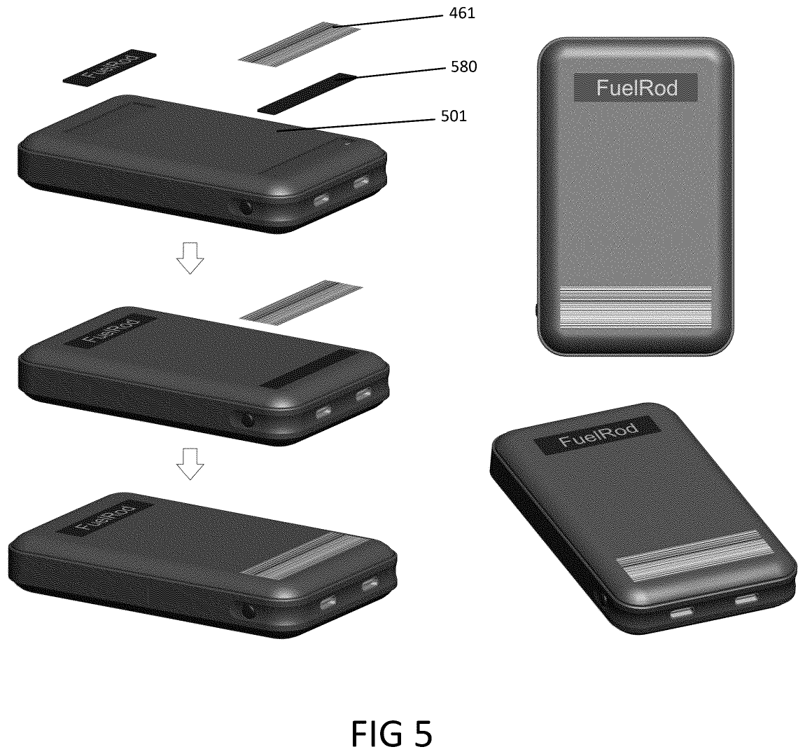

FIG. 5 includes a series of views of an embodiment of a rechargeable power unit with an identifier on top of one of the sides of the rechargeable power unit. The rechargeable power unit has a body 501. The body 501 includes a groove therein configured to receive a tag 580. The tag 580 can be a passive RFID tag encoding information about the rechargeable power unit when interrogated by an interrogation signal. The tag 580 can be covered by a label 590. The label can have a computer readable code, such as a barcode, QR code, etc. thereon, encoding an identifier for the rechargeable power unit. The tag 580 identifier can be the same as or can be associated with the identifier in the computer readable code of the label 590. Either the tag 580 or the label 590, or both can be used to identify the rechargeable power unit to a kiosk, to a mobile application, or the like, as described elsewhere herein.

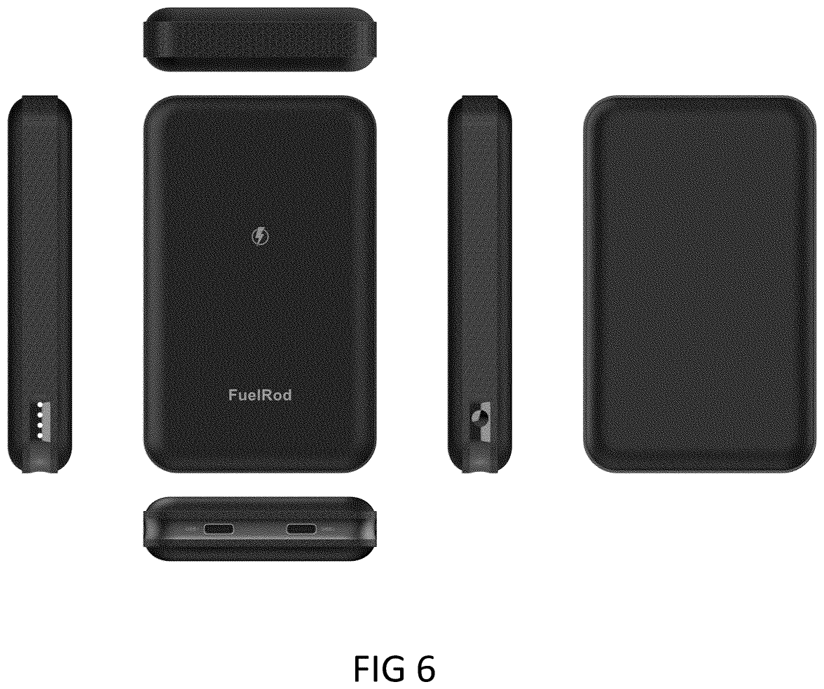

FIG. 6 includes a series of views of an embodiment of a rechargeable power unit which can be similar to those described elsewhere herein.

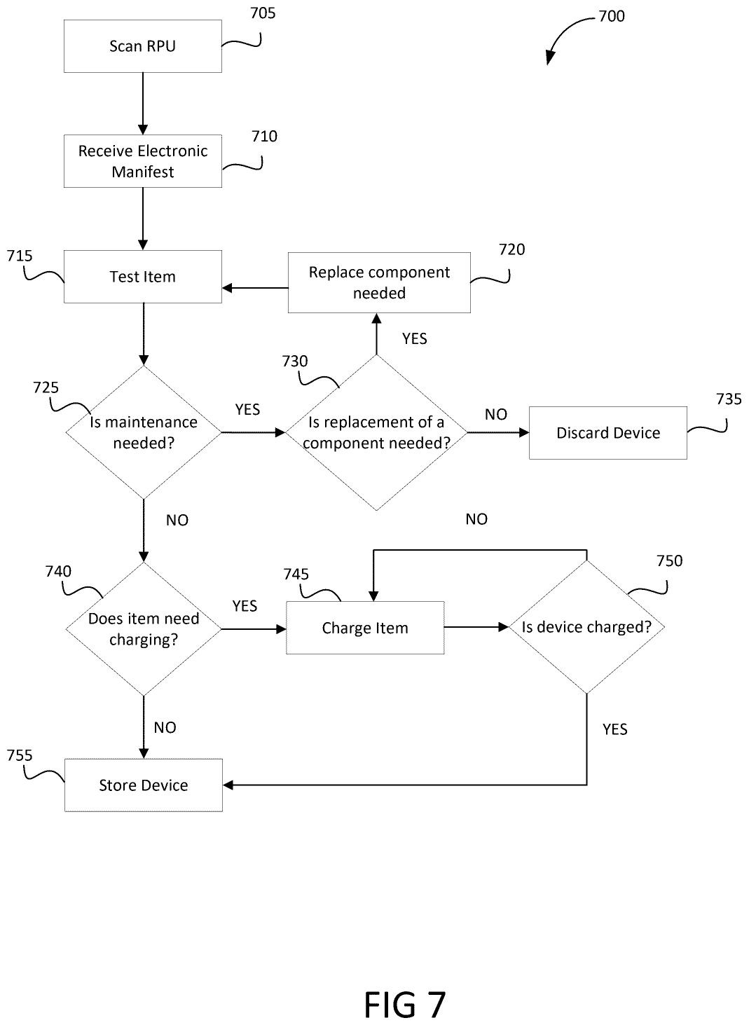

FIG. 7 is a flow chart illustrating an exemplary process for maintenance of a rechargeable power unit. The method is described with regard to the rechargeable power unit 200 as an example only. The method described herein can apply to other rechargeable power units such as described elsewhere herein.

A process 700 begins at block 705 wherein a scanner scans a rechargeable power unit (RPU). The scanner can be part of a kiosk connected to the server 110. The scanner 160 can be electrically connected to the port 230 using an automated component within the kiosk or can connect via a wireless protocol such as Bluetooth® or NFC. The scanner 160 can identify the rechargeable power unit by detecting a unique identifier stored in the rechargeable power unit. In some embodiments, the scanner can wirelessly communicate with the rechargeable power unit 200 via the processor 262. In some embodiments, the scanner 160 can comprise a barcode scanner or an imaging device and, when the rechargeable power unit 200 is scanned, the scanner can read a unique identifier on the exterior of the RPU (e.g. barcode, QR code, RFID tag, other chip embedded within, or any other computer readable code). The scanning and connection to the RPU 200 can be performed automatically within a kiosk or wirelessly as an RPU and/or a connected smartphone or other device establish a wireless connection and exchange information over a wireless link.

The process 700 moves to block 710 wherein the server 110 receives an electronic manifest based on the results of the scan from block 705 and the unique identifier of the rechargeable power unit. In some embodiments an electronic manifest can include information on the particular RPU that was scanned. For example, the date the RPU was created, how many charge cycles the battery has, if it has gotten any replaced components before. The electronic manifest can be helpful for the process 700 to understand the history on a particular RPU. In some embodiments, the electronic manifest is retrieved from the memory 150, and/or the system database 140. In some embodiments, the electronic manifest is received from the components of the RPU, such as the processor 262. In some embodiments, the electronic manifest can be stored external to the RPU and acquired by the scanner 160. In some embodiments, the electronic manifest information can be stored in the memory or storage device of the RPU. In some embodiments, the electronic manifest can be populated using both external and internal information.

The process 700 moves to block 715 wherein the test port 180 tests the rechargeable power unit 200 by running diagnostics tests on the rechargeable power unit 200. The test port 180 can test the test port via a wired connection between a connector of the test port 180 and the port of the RPU. The test port then sends the results of the diagnostics test to the server 110.

The method 700 moves to decision state 725. At decision state 725 the server 110 determines based on the results of the diagnostics tests run by the test port in block 710 and the information from the electronic manifest if maintenance is needed on the RPU and on the electronic manifest and any report from the user (for example, from a trouble ticket). For example, if the battery will not hold its charge, or a voltage is not detected from the output port, the battery may need to be replaced. If an internal fault is detected it may require maintenance on other components on the RPU 200. If the electronic manifest indicates that a battery cell has been charged and discharged greater than a threshold number of times, the server 110 can determine that the battery cell should be replaced. If the circuitry portion has been connected to a high number of different battery cells that have been replaced, this can indicate a problem with the circuitry portion which is shortening battery life, and thus the server 110 can determine that the circuitry portion should be replaced.

In some embodiments, if the scanner 160 cannot read a code on the body 201 of the RPU but can read an identifier from communication with the circuitry portion 260, the server 110 may determine that the body 201 is damaged somehow, obscuring or rendering the code on the body 201. The server 110 may then determine that the body 201 should be replaced.

One of skill in the art will understand that other conditions may exist that would necessitate the replacement of one or the other of components which are not explicitly described herein.

If in decision state 725 the server determines that maintenance is needed, then the process 400 moves to decision state 730 to determine whether a replacement of a component is needed.

If decision state 725 determines that maintenance on the RPU 200 is not needed, then the process 700 moves to decision state 740 to determine whether the RPU 200 needs charging.

Returning to decision state 730, if the processor determines that a replacement component is not needed, such that the RPU 200 cannot be fixed by the replacement of a component, then the process 700 moves to block 735 and the RPU 200 is discarded.

At decision state 730, if it is determined that a replacement component is needed then the process 700 moves to block 720, wherein the faulty component is replaced. The replacement can be made via an automated system within the kiosk. In some embodiments, the RPU can be automatically moved to a storage location within the kiosk where RPUs needing replacement components are stored until they can be picked up and have maintenance performed. A replacement component needed to be changed can include any of the components mentioned above. For example, if the battery cell 270 is malfunctioning or is not charging, it may be replaced and the rest of the RPU 200 will be restored to working condition. Once the faulty component is replaced, the process 700 then moves to block 715 and tests the RPU after the is replaced.

In some embodiments, at decision state 720 when the components of the RPU 200 are replaced, the processor sends signals to the memory that the applicable components have been replaced. The signals sent to the memory are stored and the serial number is associated with a new number of cycles for that particular component. For example, if the battery is replaced then the new battery would have an identification number stored in the memory that is has currently zero charge cycles associated with it. The memory also keeps track of the number of charge cycles for the rest of the components the same way.

Returning to decision state 740, if the server determines that the RPU 200 does not need to be charged, then the process 700 moves to block 755 wherein the RPU is stored within the user interface.

At decision state 740, if the server determines that the RPU 200 needs to be charged, then the process 700 moves to block 745 wherein the charger charges the RPU. The charger charges the RPU using robotic or automated equipment. In some embodiments, the test port 180 may charge the RPU using the connection made in step 305. In some embodiments, the RPU can be automatically moved to a portion of the kiosk and automatically connected to a charging port.

The process 700 moves to decision state 750 wherein the server determines whether the item is charged. If the server determines that the RPU is charged, then the process 700 moves to block 755 wherein the RPU is stored.

If at decision state 750, the server determines that the RPU 200 is not charged, then the process 700 moves back to block 745 wherein the charger charges the RPU 200.

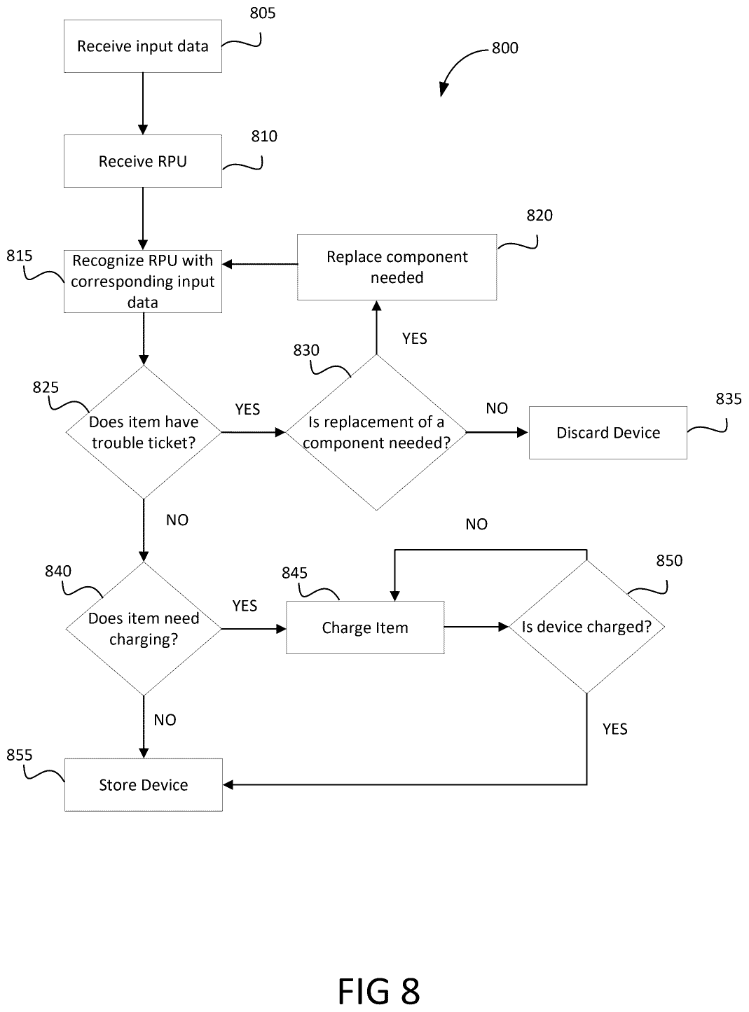

FIG. 8 is an exemplary flow chart illustrating an exemplary process for maintenance of a rechargeable power unit with input data on the malfunctions of the RPU. Methods described in FIG. 8 relate to the rechargeable power unit described elsewhere herein. A process 800 begins at block 805 wherein the user interface receives input data regarding the problems associated with the RPU. For example, the input data may report that the battery component of the RPU no longer charges, or that it will not hold its charge. The input data may also report that the RPU may have some cosmetic damage on the outside or water damage on the inside.

The process 800 moves to block 810 wherein the RPU is received. The process 800 moves to block 815 wherein the server recognizes the RPU with corresponding input data previously received from a user interface.

The process 800 moves to decision state 825 wherein the server determines if the RPU has a trouble ticket. A trouble ticket may have been created previously when the user interface received the input data on the RPU with the problems the RPU has. For example, if the user interface received input data that the battery of the RPU will not hold its charge, then a trouble ticket may have been created to direct the replacement of the battery component. Or a trouble ticket may have been created based on the input data from the user interface that states that the problems acknowledged with the particular RPU cannot be fixed with a replacement of a component.

If at decision state 825 the server determines that the RPU has a trouble ticket, then the process 800 moves to decision state 830.

If at decision state 825 the server determines that the RPU does not have a trouble ticket, then the process 500 moves to decision state 840.

Returning to decision state 830, if the server determines that a replacement of a component is not needed the process 800 moves to block 835 and the RPU is discarded.

If at decision state 830 the server determines that a replacement of a component is needed, then the process 800 moves to block 820 and the faulty component is replaced, as described elsewhere herein. From block 820 the process 800 moves back to block 815 and continues on with the process as described above.

In some embodiments, at decision state 820 when the components of the RPU 200 are replaced, the processor sends signals to the memory that the applicable components have been replaced. The signals sent to the memory are stored and the serial number is associated with a new number of cycles for that particular component. For example, if the battery is replaced then the new battery would have an identification number stored in the memory that is has currently zero charge cycles associated with it. The memory also keeps track of the number of charge cycles for the rest of the components the same way.

Returning to decision state 840, if the server determines that the RPU 200 does not need to be charged, then the process 800 moves to block 855 wherein the RPU is stored within the user interface.

At decision state 840, if the server determines that the RPU 200 needs to be charged, then the process 800 moves to block 845 wherein the charger charges the RPU 200 as describe elsewhere herein.

The process 800 moves to decision state 850 wherein the server determines whether the item is charged. If the server determines that the RPU is charged, then the process 800 moves to block 855 wherein the RPU is stored.

If at decision state 850, the server determines that the RPU 200 is not charged, then the process 800 moves back to block 845 wherein the charger charges the RPU 200.

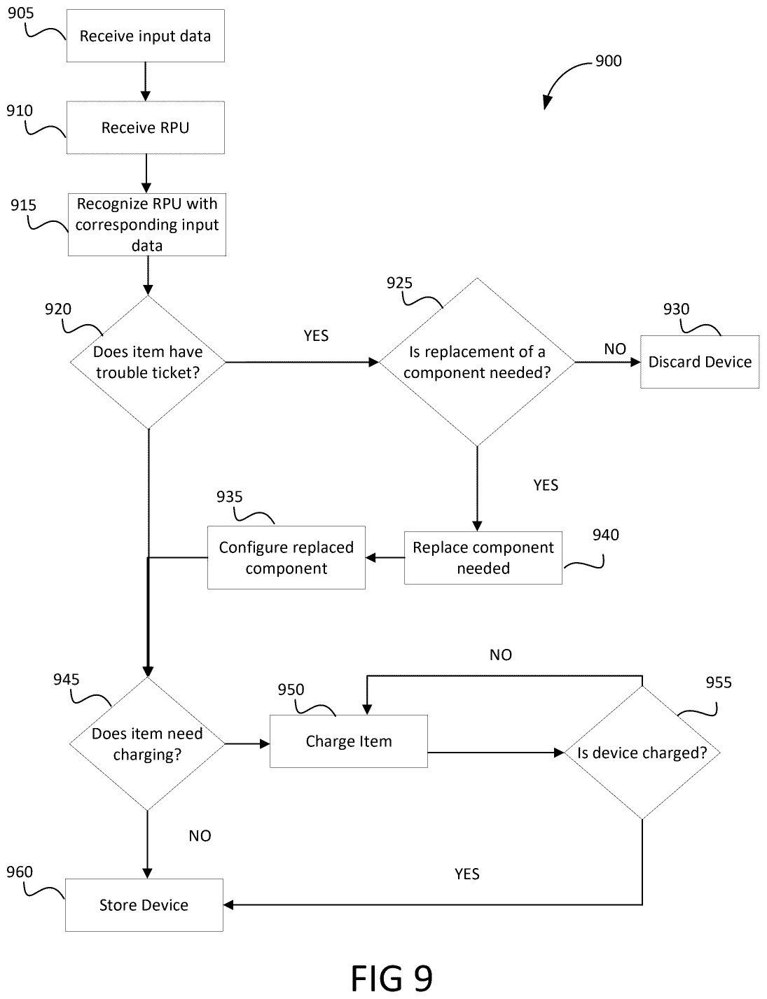

FIG. 9 is an exemplary flow chart illustrating an exemplary process for maintenance of a rechargeable power unit with input data on the malfunctions of the RPU. Methods described in FIG. 9 relate to the rechargeable power unit described elsewhere herein. A process 900 begins at block 905 wherein the user interface receives input data regarding the problems associated with the RPU. For example, the input data may report that the battery component of the RPU no longer charges, or that it will not hold its charge. The input data may also report that the RPU may have some cosmetic damage on the outside or water damage on the inside.

The process 900 moves to block 910 wherein the RPU is received in a kiosk or other similar device.

The process 900 moves to block 915 wherein the server recognizes the RPU with corresponding input data previously received from a user interface.

The process 900 moves to decision state 920 wherein the server determines if the RPU has a trouble ticket. A trouble ticket may have been created previously when the user interface received the input data on the RPU with the problems the RPU has. For example, if the user interface received input data that the battery of the RPU will not hold its charge, then a trouble ticket may have been created to direct the replacement of the battery component. Or a trouble ticket may have been created based on the input data from the user interface that states that the problems acknowledged with the particular RPU cannot be fixed with a replacement of a component.

If at decision state 920 the server determines that the RPU has a trouble ticket, then the process 900 moves to decision state 925.

If at decision state 920 the server determines that the RPU does not have a trouble ticket, then the process 900 moves to decision state 945.

Returning to decision state 925, if the server determines that a replacement of a component is not needed the process 900 moves to block 930 and the RPU is discarded.

If at decision state 925 the server determines that a replacement of a component is needed, then the process 900 moves to block 940 and the faulty component is replaced. In some embodiments, at decision state 640 when the components of the RPU 200 are replaced, the processor sends signals to the memory that the applicable components have been replaced. The signals sent to the memory are stored and the serial number is associated with a new number of cycles for that particular component. For example, if the battery is replaced then the new battery would have an identification number stored in the memory that is has currently zero charge cycles associated with it. The memory also keeps track of the number of charge cycles for the rest of the components the same way.

The process 900 then moves to block 935 wherein the server configures the replaced component with the RPU. For example, if the trouble ticket had stated that the battery of the RPU needed to be replaced, then the battery would be replaced at block 940 and at block 935 the server would configure the RPU with the new battery that was replaced. The battery would be configured so that the system database would now that the corresponding RPU has a new battery with a different number of charge cycle numbers than the old battery.

Each component of the RPU 200 may have an identifier, such as a serial number. For example, the battery cell can have a unique identifier, the processor can have a unique identifier associated therewith, etc. within an RPU, the circuitry portion stores in a memory the identifier for the battery cell, for the processor, and the identifier on the body 210 or the serial number of the RPU. These identifiers are all associated in the circuitry portion 260, and are associated on the electronic manifest, along with information about the components. For example, a begin service date, a number of charge-discharge cycles, a number of times used, or other information can be stored in the memory and/or in the electronic manifest for the RPU. When the battery cell is removed and replaced, and connected to a circuitry portion, the circuitry portion needs to be updated to indicate the new battery cell identifier and to reset a charge-discharge counter, voltages, etc. corresponding to the new battery cell. If the body 201 is replaced, the circuitry portion needs to be updated to include the identifier encoded in the computer readable code on the label or the outer surface of the RPU or encoded in the RFID tag if the RPU has one. This will associate the battery cell and the processor with the new RPU. In some embodiments, if the circuitry portion is replaced and attached to a used but otherwise healthy battery cell, the new circuitry portion needs to have the battery cell identifier and other information about the battery cell, such as battery life, service dates, charge-discharge cycle numbers, etc., written to the memory in the new circuitry portion. Additionally, the RPU 200 identifier should be written to the memory in the new circuitry portion, and all the information should be updated on the electronic manifest. The server 110 can control the operation of the test port 180 and the scanner 160 to accomplish the updating of information when a component of the RPU is replaced. This process is described with regard to process 900, but it can be equally applicable to other processes or embodiments described herein.

Returning to decision state 945, if the server determines that the RPU 200 does not need to be charged, then the process 900 moves to block 960 wherein the RPU is stored within the user interface.

At decision state 945, if the server determines that the RPU 200 needs to be charged, then the process 900 moves to block 950 wherein the charger charges the RPU 200.

The process 900 moves to decision state 955 wherein the server determines whether the item is charged. If the server determines that the RPU is charged, then the process 900 moves to block 960 wherein the RPU is stored. If at decision state 955, the server determines that the RPU 200 is not charged, then the process 900 moves back to block 950 wherein the charger charges the RPU 200.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A rechargeable power unit comprising:
a body;
a battery cell removably positioned within the body;
a board comprising a processor, a memory, an input/output port, and a battery connection removably connected to the battery cell;
a casing removably connected to the board via a mechanical connection; and
a connection portion removably connected to the body, the connection portion housing at least a portion of the casing and the board and including an opening configured to provide access to the input/output port.

2. The rechargeable power unit of claim 1, further comprising a wireless charging coil, the wireless charging coil removably connected to the board.

3. The rechargeable power unit of claim 1, the body having a computer readable code located thereon.

4. The rechargeable power unit of claim 1, wherein the memory is configured to store a battery identifier, processor identifier, and the computer readable code located on the body.

5. The rechargeable power unit of claim 1, wherein the processor is further configured to determine one or more attributes of the battery cell, the board, and the body, and store the one or more attributes in the memory.

6. The rechargeable power unit of claim 5, wherein the one or more attributes comprise battery service date, number of charge-discharge cycles, average of battery percentage increased per charge of rechargeable power unit, number of times interchangeable component has been replaced, and number of days since interchangeable component has been replaced.

7. The rechargeable power unit of claim 1, wherein the casing comprises one or more prongs extending from a surface thereof and wherein the board comprises one or more slots configured to receive the one or more prongs of the casing such that a secure friction fit is formed between the casing and the board.

8. The rechargeable power unit of claim 1, wherein the casing fits within the connection portion such that the casing is removably secured within the connection portion and the input/output port of the board is aligned with the opening in the connection portion.

9. The rechargeable power unit of claim 1, further comprising a sealing strip covering at least a portion of a joint between the connection portion and the body.

10. The rechargeable power unit of claim 9, wherein the sealing strip further comprises one or more electrical contacts in communication with processor, and wherein removing the sealing strip breaks the one or more electrical contacts, and wherein the processor is configured to prevent operation of the rechargeable power unit where the one or more electrical contacts are broken.

11. A method of maintaining a rechargeable power unit, the method comprising:
scanning, by a scanner, a rechargeable power unit to read an identifier associated with the rechargeable power unit, the rechargeable power unit comprising a body, a casing, a board, and a battery cell, the board removably connected to the battery cell and the board removably connected to the casing and the body housing the battery cell;
storing in a processor on the board, item information, the item information including a unique battery identifier, a unique processor identifier, and the identifier associated with the rechargeable power unit;
receiving item information for components of the rechargeable power unit;
identifying, based on the item information, that one or more components of the rechargeable power unit need to be replaced;
determining, based on the identifying that one or more components need to be replaced, which of the board, battery cell, and body needs to be replaced; and
storing, in the memory of the board, an updated identifier corresponding to a replacement component.

12. The method of claim 11, further comprising:
running a diagnostic test of the rechargeable power unit;
determining, based on the diagnostic test, that the battery cell needs to be replaced; and wherein storing the updated identifier comprises storing, in the memory, a new unique identifier corresponding to a replacement battery cell.

13. The method of claim 11, wherein scanning the rechargeable power unit comprises making an electrical connection with the scanner and the rechargeable power unit in a receptacle.

14. The method of claim 11, wherein scanning the rechargeable power unit comprises:
making a wireless connection between the receptacle and the rechargeable power unit; and
receiving the item information from the rechargeable power unit via the wireless connection.

15. The method of claim 11 further comprising:
receiving, from a user via a user interface, trouble information for the rechargeable power unit; and wherein identifying, based on the item information, that one or more components of the rechargeable power unit need to be replaced further comprises identifying, based on the item information and the trouble information, that one or more components of the rechargeable power unit need to be replaced.

16. The method of claim 15, wherein the user interface is connected to a receptacle configured to receive the rechargeable power unit.

17. The method of claim 15, wherein the user interface is embodied as an application running on a user device.

18. The method of claim 11, wherein receiving the item information for the components of the rechargeable power unit comprises receiving the item information from the processor on the board via the scanner.

19. The method of claim 11 further comprising updating, by a server in a memory remote from the rechargeable power unit, the updated identifier corresponding to the replacement component.

20. The method of claim 11, wherein receiving the item information for the components of the rechargeable power unit comprises:
querying, by a server, a memory remote from the rechargeable power unit, using the scanned identifier; and
receiving, from the memory, the item information for the components of the rechargeable power unit.
